(19) United States
(12) Patent Application Publication
(10) Pub. No.: US 2016/0215433 A1
(43) Pub. Date: Jul. 28, 2016

(54) UNITARY TOP PANEL FOR A WASHING MACHINE APPLIANCE

(71) Applicant: General Electric Company, Schenectady, NY (US)

(72) Inventor: James Quentin Pollett, Louisville, KY (US)

(21) Appl. No.: 14/607,203

(22) Filed: Jan. 28, 2015

(51) Int. Cl. D06F 39/02; B22F 3/105; B29C 67/00; D06F 23/04

(52) U.S. Cl. CPC D06F 39/022; D06F 23/04; B22F 3/1055; B29C 67/0088; B33Y 10/00

(57) ABSTRACT

A unitary top panel for a vertical axis washing machine appliance is provided. The unitary top panel defines a fluid conduit coupling, an interior volume and a plurality of outlets. The interior volume of the unitary top panel extends between and fluidly connects the fluid conduit coupling and the plurality of outlets. A related method for forming a unitary top panel for a vertical axis washing machine appliance is also provided.

### FIELD OF THE INVENTION

The present subject matter relates generally to top panels for vertical axis washing machine appliances.

### BACKGROUND OF THE INVENTION

Washing machine appliances commonly utilize wash and rinse fluids to clean clothing articles disposed within wash baskets of the washing machine appliances. Wash fluids can include, for example, water and various fluid additives, such as detergent, fabric softener and/or bleach. To form wash fluids, water may be mixed with the fluid additives within the washing machine appliances.

Fluid additives may be mixed with water at various locations in washing machine appliances. For example, a user can manually add one or more fluid additives to the wash tub and/or the wash basket. In particular, after starting the appliance, the user can pour detergent directly into the wash basket, and water entering the wash basket may mix with the detergent to form wash fluid. As another example, certain washing machine appliances include features for receiving fluid additives and dispensing the fluid additives during operation of the appliance. The fluid additive dispenser can receive a fluid additive and direct the fluid additive into the wash tub of the vertical axis washing machine appliance. Such dispensers may contain one or more compartments for the receipt of respective fluid additives.

Fluid additive dispenser can have certain drawbacks. For example, completely rinsing the fluid additive dispenser and removing all fluid additives from the fluid additive dispenser can be difficult. Overtime, films and residues can accumulate within the fluid additive dispenser and hinder proper operation of the fluid additive dispenser. As another example, certain fluid additive dispensers require complex plumbing, including fittings and nozzles. Such pluming can be expensive to manufacture and can provide numerous joints where leaks can develop.

Accordingly, a washing machine appliance with a fluid additive dispenser and features for improving performance of the fluid additive dispenser would be useful. More particularly, a washing machine appliance with features for assisting with completely rinsing a fluid additive dispenser of the washing machine appliance would be useful.

### BRIEF DESCRIPTION OF THE INVENTION

The present subject matter provides a unitary top panel for a vertical axis washing machine appliance. The unitary top panel defines a fluid conduit coupling, an interior volume and a plurality of outlets. The interior volume of the unitary top panel extends between and fluidly connects the fluid conduit coupling and the plurality of outlets. A related method for forming a unitary top panel for a vertical axis washing machine appliance is also provided. Additional aspects and advantages of the invention will be set forth in part in the following description, or may be apparent from the description, or may be learned through practice of the invention.

In a first exemplary embodiment, a vertical axis washing machine appliance is provided. The vertical axis washing machine appliance includes a tub and a basket positioned within the tub. The basket is rotatable about a vertical axis within the tub. A fluid additive drawer defines a fluid additive compartment. A cabinet extends between a top portion and a bottom portion. The tub is disposed within the cabinet. The cabinet has a unitary top panel positioned at the top portion of the cabinet. The unitary top panel defines an opening for accessing the basket within the tub. The unitary top panel also defines a fluid conduit coupling, an interior volume and a plurality of outlets. The interior volume of the unitary top panel extends between and fluidly connects the fluid conduit coupling and the plurality of outlets. The plurality of outlets is positioned over the fluid additive compartment of the fluid additive drawer.

In a second exemplary embodiment, a method for forming a unitary top panel for a vertical axis washing machine appliance is provided. The method includes establishing three-dimensional information of the unitary top panel and converting the three-dimensional information of the unitary top panel from the step of establishing into a plurality of slices. Each slice of the plurality of slices defines a respective cross-sectional layer of the unitary top panel. The method also includes successively forming each cross-sectional layer of the unitary top panel with an additive process.

After the step of successively forming: (1) the unitary top panel defines an opening for accessing a basket of the vertical axis washing machine appliance; (2) the unitary top panel also defines a fluid conduit coupling, an interior volume and a plurality of outlets; and (3) the interior volume of the unitary top panel extends between and fluidly connects the fluid conduit coupling and the plurality of outlets.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter with a door of the exemplary washing machine appliance shown in a closed position.

FIG. 2 provides a perspective view of the exemplary washing machine appliance of FIG. 1 with the door shown in an open position.

FIG. 3 provides a top, perspective view of a unitary top panel of the exemplary washing machine appliance of FIG. 1.

FIG. 4 provides a bottom, plan view of the unitary top panel of the exemplary washing machine appliance of FIG. 1.

FIG. 5 provides a partial, section view of the unitary top panel of FIG. 3 taken along the 5-5 line of FIG. 3.

FIG. 6 provides a partial, section view of the unitary top panel of FIG. 3 taken along the 6-6 line of FIG. 3.

FIG. 7 illustrates a method for forming a unitary top panel according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

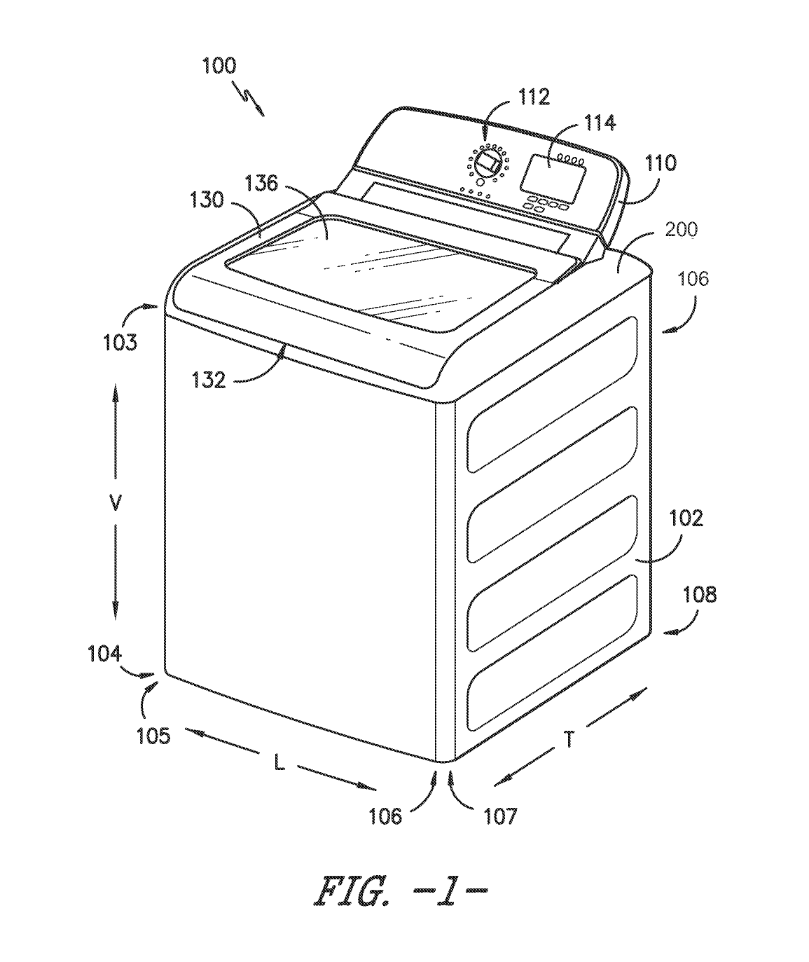

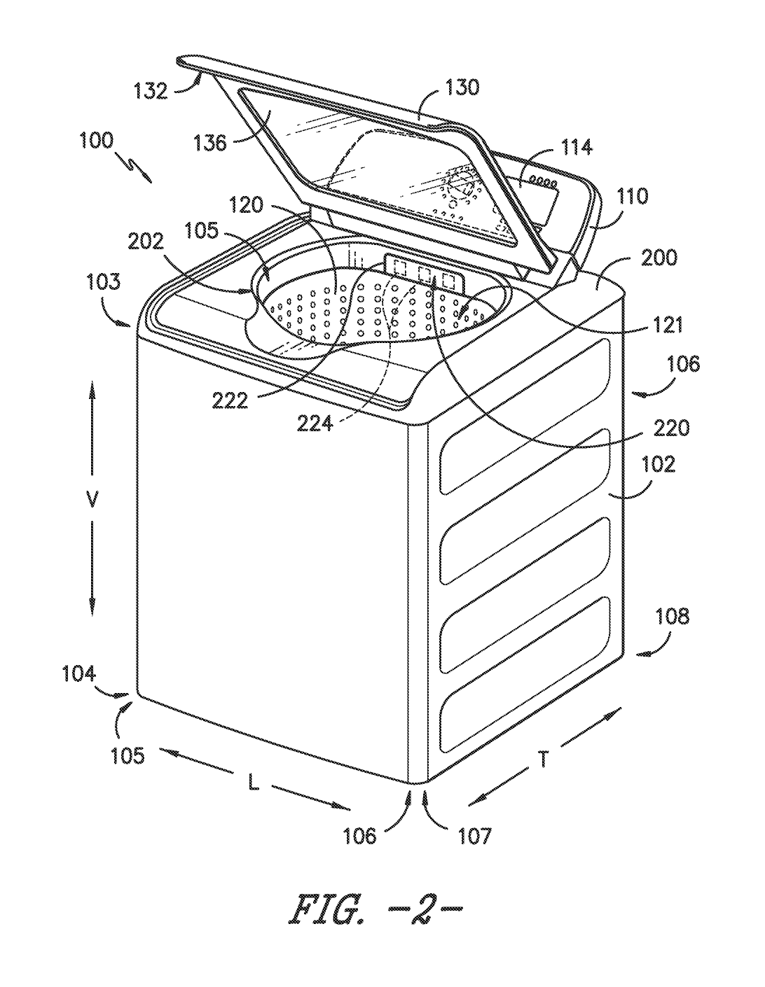

FIGS. 1 and 2 illustrate an exemplary embodiment of a vertical axis washing machine appliance 100. In FIG. 1, a lid or door 130 is shown in a closed position. In FIG. 2, door 130 is shown in an open position. While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, and/or different features may also be utilized with the present subject matter as well.

As may be seen in FIGS. 1 and 2, washing machine appliance 100 defines a vertical direction V, a lateral direction L and a transverse direction T. The vertical direction V, lateral direction L and transverse direction T are mutually perpendicular and form an orthogonal direction system. Washing machine appliance 100 has a cabinet 102 that extends between a top portion 103 and a bottom portion 104 along the vertical direction V. Cabinet 102 also extends between a first side portion 105 and a second side portion 106, e.g., along the lateral direction L, and a front portion 107 and a back portion 108, e.g., along the transverse direction T.

A wash basket 120 is rotatably mounted within cabinet 102, e.g., within a wash tub (not shown) disposed within cabinet 102. A motor (not shown) is in mechanical communication with wash basket 120 in order to selectively rotate wash basket 120, e.g., during an agitation or a rinse cycle of washing machine appliance 100. Wash basket 120 defines a wash chamber 121 that is configured for receipt of articles for washing. An agitator or impeller (not shown) extends from wash basket 120 into wash chamber 121. The impeller assists agitation of articles disposed within wash chamber 121 during operation of washing machine appliance 100.

Cabinet 102 of washing machine appliance 100 has a top panel 200 positioned at or adjacent top portion 103 of cabinet 102. Top panel 200 defines an opening 202 that permits user access to wash chamber 121 of wash basket 120. Door 130 is rotatably mounted to top panel 200. However, alternatively, door 130 may be mounted to cabinet 102 or any outer suitable support. Door 130 selectively rotates between the closed position shown in FIG. 1 and the open position shown in FIG. 2. In the closed position, door 130 inhibits access to wash chamber 121. Conversely, in the open position, a user can access wash chamber 121. A window 136 in door 130 permits viewing of wash chamber 121 when door 130 is in the closed position, e.g., during operation of washing machine appliance 100. Door 130 also includes a handle 132 that, e.g., a user may pull and/or lift when opening and closing door 130.

As may be seen in FIG. 2, top panel 200 includes at least one fluid additive dispenser 220, such as the fluid additive dispenser described in U.S. patent application Ser. No. 14/457,313 of Leibman et al., which is hereby incorporated by reference for all purposes. Fluid additive dispenser 220 is configured for receipt and dispensing of one or more fluid additives, such as detergent, fabric softener and/or bleach. In particular, fluid additive dispenser 220 includes a fluid additive drawer 222 that defines at least one fluid additive well or compartment 224 therein. As an example, fluid additive drawer 222 may be opened, and a user of washing machine appliance 100 may fill each one of fluid additive compartments 224 with a respective fluid additive. The user may then close the fluid additive drawer 222, and fluid additive dispenser 220 may dispense the fluid additives from fluid additive compartments 224 of fluid additive drawer 222 during operation of washing machine appliance 100. Fluid additive compartments 224 may be configured as integrally formed or removable dispenser cups. Fluid additive drawer 222 may be configured with any suitable number of fluid additive compartments 224, e.g., one, two, or three or more compartments.

While only one fluid dispenser will be described herein, it should be understood that multiple fluid dispensers may be used in alternative embodiments of the invention. In the exemplary embodiment shown in FIG. 2, fluid additive dispenser 220 is positioned above wash tub 121 at or adjacent back portion 108 of cabinet 102. In alternative exemplary embodiments, fluid additive dispenser 220 may be positioned at any other suitable location on top panel 200. Fluid additive dispenser 220 is described in greater detail below.

A control panel 110 with a plurality of input selectors 112 extends from top panel 200 at top portion 103 of cabinet 102. Control panel 110 and input selectors 112 collectively form a user interface input for operator selection of machine cycles and features. A display 114 of control panel 110 indicates selected features, a countdown timer, and/or other items of interest to appliance users.

Operation of washing machine appliance 100 is controlled by a controller or processing device (not shown) that is operatively coupled to control panel 110 for user manipulation to select washing machine cycles and features. In response to user manipulation of control panel 110, the controller operates the various components of washing machine appliance 100 to execute selected machine cycles and features.

In an illustrative embodiment, laundry items are loaded into wash chamber 121 through opening 202, and washing operation is initiated through operator manipulation of input selectors 112. Wash basket 120 or the wash tub is filled with water and detergent to form a wash fluid. One or more valves (not shown) can be controlled by washing machine appliance 100 to provide for filling wash basket 120 to the appropriate level for the amount of articles being washed. Once wash basket 120 is properly filled with fluid, the contents of wash chamber 121 are agitated (e.g., with the impeller) for cleansing of laundry items in wash basket 120.

After the agitation phase of the wash cycle is completed, wash basket 120 is drained. Laundry articles can then be rinsed by again adding fluid to wash basket 120, depending on the particulars of the cleaning cycle selected by a user, the impeller may again provide agitation within wash chamber 121. One or more spin cycles may also be used. In particular, a spin cycle may be applied after the wash cycle and/or after the rinse cycle in order to wring wash fluid from the articles being washed. During a spin cycle, wash basket 120 is rotated at relatively high speeds. After articles disposed in wash basket 120 are cleaned and/or washed, the user can remove the articles from wash basket 120, e.g., by reaching into wash chamber 121 through opening 202.

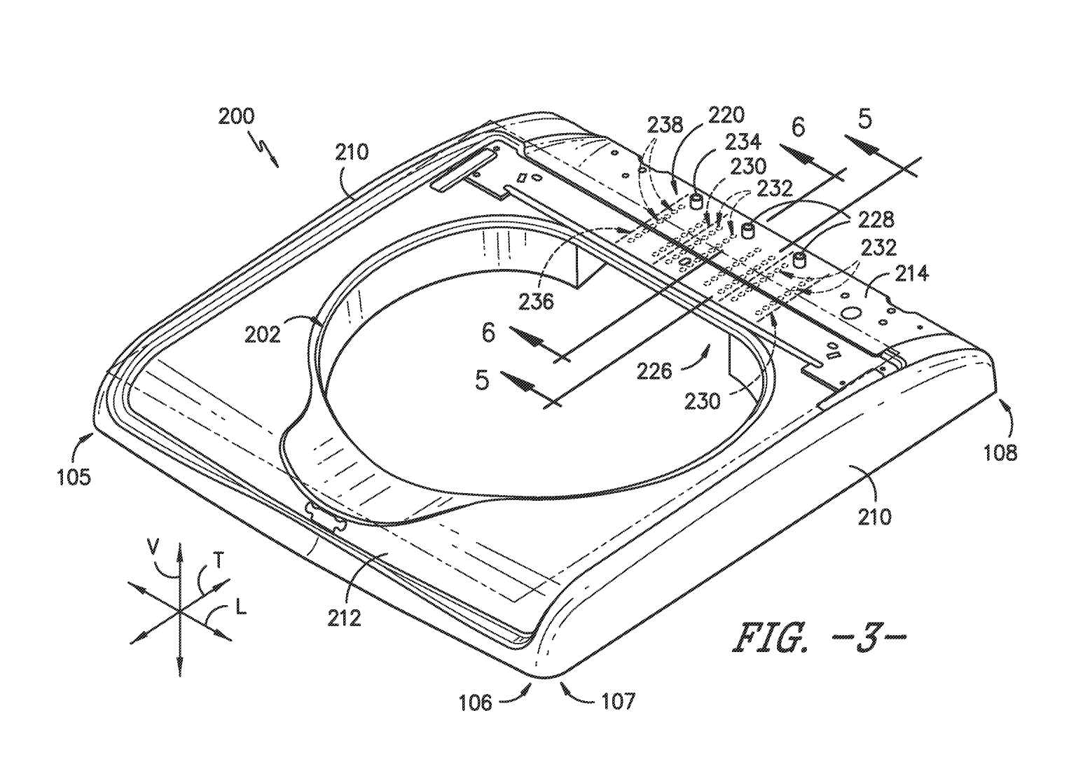

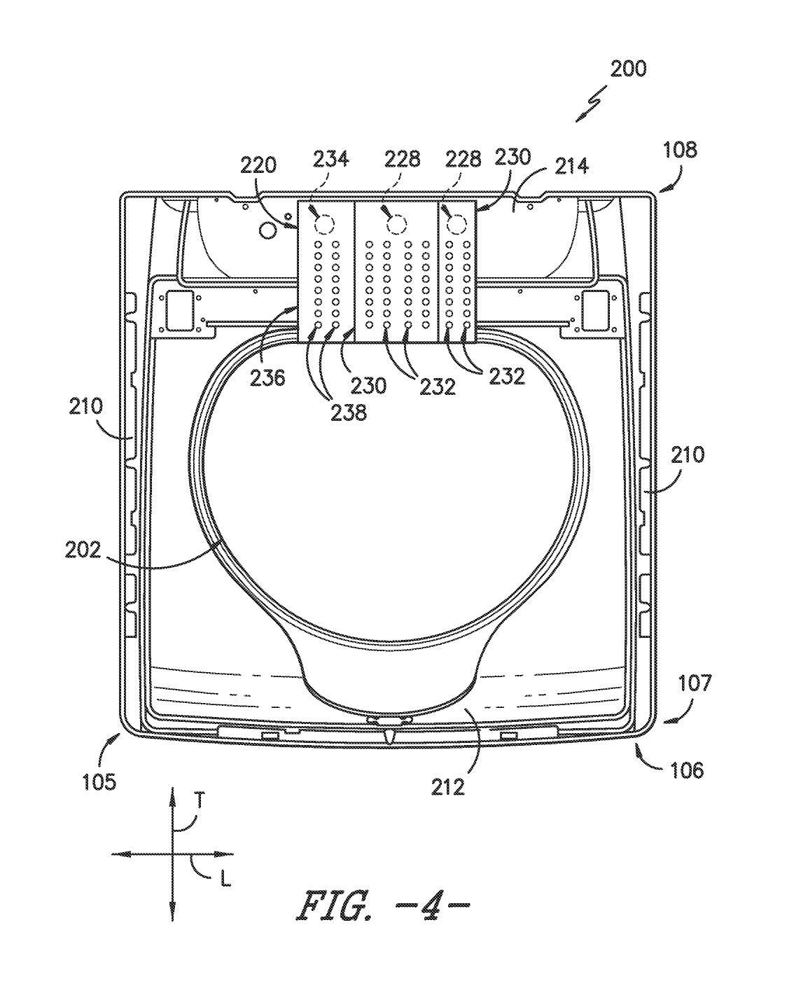

FIG. 3 provides a top, perspective view of top panel 200. FIG. 4 provides a bottom, plan view of top panel 200. As may be seen in FIGS. 3 and 4, components of top panel 200 are integral or unitary with one another. Thus, top panel 200 is a unitary top panel, e.g., such top panel 200 is constructed of or with a single continuous piece of material, such as a plastic or metal, as discussed in greater detail below.

Top panel 200 includes a pair of side rails or frame members 210, a front rail or frame member 212 and a back rail or frame member 214. Each one of side frame members 210 is positioned at or adjacent a respective one of first and second side portions 105, 106 of cabinet 102 (FIG. 2). Thus, side frame members 210 are spaced apart from each other along the lateral direction L and positioned at opposite sides of top panel 200 along the lateral direction L. Front frame member 212 is positioned at or adjacent front portion 107 of cabinet 102, and back frame member 214 is positioned at or adjacent back portion 108 of cabinet 102. Thus, front frame member 212 and back frame member 214 are spaced apart from each other along the transverse direction T and positioned at opposite sides of top panel 200 along the transverse direction T. Side frame members 210, front frame member 212 and back frame member 214 assist with defining opening 202, e.g., at a center of top panel 200. Side frame members 210, front frame member 212 and back frame member 214 are integrally formed with one another, e.g., such that side frame members 210, front frame member 212 and back frame member 214 are constructed of or with a single continuous piece of material, such as a plastic or metal.

As may be seen in FIGS. 3 and 4, fluid additive drawer 222 may slidably mount to top panel 200 at a drawer housing 226 of top panel 200, e.g., that is defined by back frame member 214. Thus, fluid additive drawer 222 may slide into and out top panel 200 at drawer housing 226 of top panel 200. Fluid additive dispenser 220 is configured to receive a flow of hot and/or cold water, e.g., from valves (not shown) coupled to fluid additive dispenser 220. The valves regulate the flow of water into fluid additive dispenser 220 to convey water or a mixture of water and fluid additive to wash basket 120. Whether hot or cold water is supplied to fluid additive dispenser 220 may depend on the wash cycle selected by a user of washing machine appliance 100. Alternatively, one or more fluid additive compartment 224 of fluid additive drawer 222 may be designated to receive a particular fluid additive, and whether hot or cold water is supplied to one of fluid additive compartments 224 may depend on the designated fluid additive of an associated wash cycle and the type of wash fluid within each one of fluid additive compartments 224.

Within each one of fluid additive compartments 224, water may mix with fluid additive therein to form a suitable wash fluid. The wash fluid may then flow out of fluid additive dispenser 220 into wash basket 120. The mixture of water and fluid additive may be conveyed to directly into wash basket 120 or indirectly to wash basket 120, e.g., via pipes, tubes, or the like. As described above, the mixture of water and fluid additive flows to wash basket 120 to assist with washing or rinsing laundry articles contained in wash basket 120. In addition, water without fluid additives may be provided to wash basket 120 through fluid additive dispenser 220 to assist with washing or rinsing laundry articles contained in wash basket 120.

Top panel 200 includes various features for directing liquid into fluid additive compartments 224 of fluid additive drawer 222. In particular, as may be seen in FIGS. 3 and 4, top panel 200 defines fluid conduit couplings 228, interior volumes 230 and outlets 232. Liquid conduits, such as hoses, pipes, etc., may be connected or coupled to fluid conduit couplings 228 such that liquid from such liquid contacts may flow through fluid conduit couplings 228 into interior volumes 230 of top panel 200. As an example, a hose may be threaded onto each of fluid conduit couplings 228 and/or a pipe may be adhered or soldered onto each one of fluid conduit couplings 228 in order to supply fluid additive dispenser 220 with liquid to form wash fluids. In addition, respective valves may be mounted, e.g., threaded, press-fit, spin welded, etc., to each one of fluid conduit couplings 228 in order to regulate fluid flow into fluid additive dispenser 220.

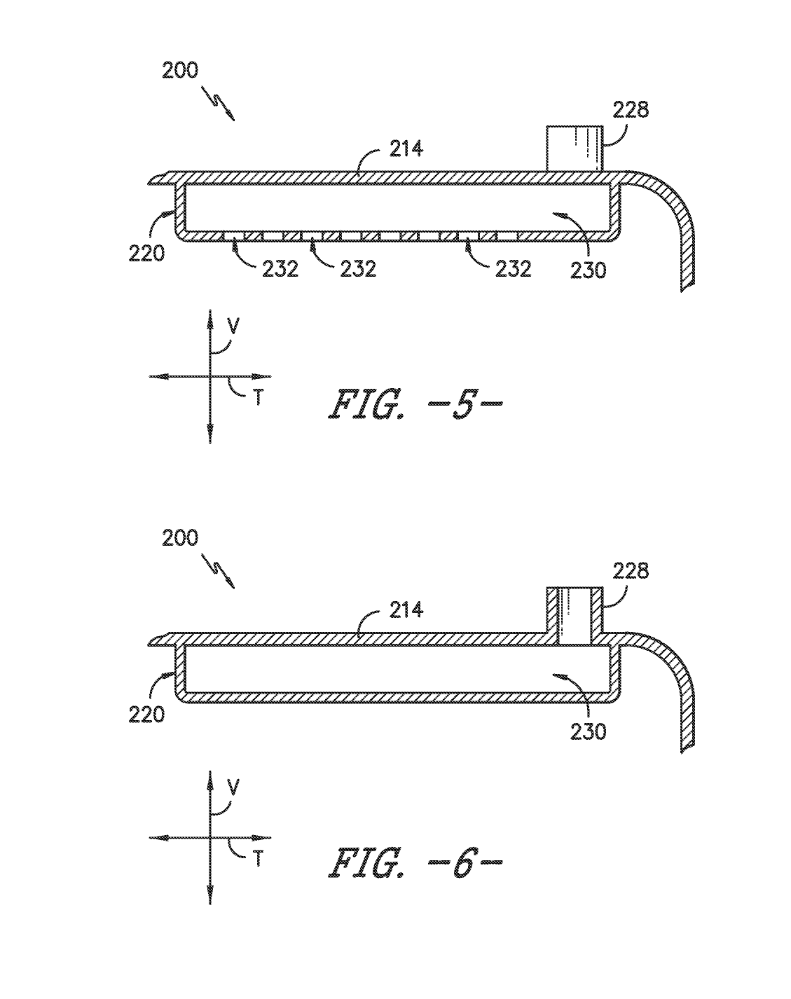

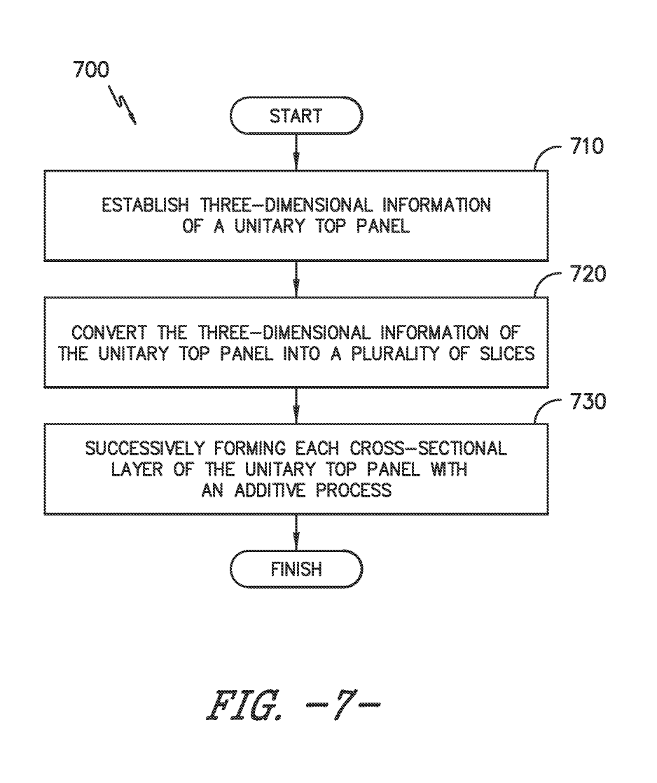

FIG. 5 provides a partial, section view of top panel 200 taken along the 5-5 line of FIG. 3. FIG. 6 provides a partial, section view of top panel 200 taken along the 6-6 line of FIG. 3. As may be seen in FIGS. 5 and 6, each interior volume of interior volumes 230 extends between and fluidly connects a respective fluid conduit coupling of fluid conduit couplings 228 and respective outlets of outlets 232. For example, turning back to FIGS. 3 and 4, top panel 200 defines a first fluid conduit coupling 234, a first interior volume 236 and a first plurality of outlets 238, and first interior volume 236 extends between and fluidly connects first fluid conduit coupling 234 and outlets 238. Thus, wash fluid from fluid conduit couplings 228 may flow to outlets 232 within top panel 200 via interior volumes 230 of top panel 200.

As may be seen in FIGS. 2, 3 and 4, outlets 232 of top panel 200 are positioned over fluid additive drawer 222, e.g., when fluid additive drawer 222 is closed. In particular, respective outlets of outlets 232 may be positioned over each fluid additive compartment 224 of fluid additive drawer 222 when fluid additive drawer 222 is closed. Thus, liquid exiting interior volumes 230 of top panel 200 at outlets 232 of top panel 200 may flow into fluid additive compartments 224 of fluid additive drawer 222 in order to form wash fluid with fluid additive dispenser 220 in the manner described above. Outlets 232 may have any suitable number of outlets. For example, each respective group of outlets 232 positioned over fluid additive compartments 224 of fluid additive drawer 222 may include more than four outlets and less than two hundred outlets. As another example, each respective group of outlets 232 positioned over fluid additive compartments 224 of fluid additive drawer 222 may include at least twenty outlets, as shown in the exemplary embodiment of FIG. 4. In alternative exemplary embodiments, a single outlet of outlets 232 may be positioned over each fluid additive compartment 224 of fluid additive drawer 222. In such exemplary embodiments, each outlet of outlets 232 may be shaped to match or complement a perimeter or shape of a respective fluid additive compartment 224 of fluid additive drawer 222, e.g., in a plane that is perpendicular to the vertical direction V.

Outlets 232 may have any suitable distribution or arrangement. For example, as shown in FIGS. 3 and 4, outlets 232 may be spaced apart from one another along at least one of the lateral direction L and the transverse direction T. In addition, as shown in FIGS. 4 and 6, none of outlets 232 may be positioned directly beneath fluid conduit couplings 228 along the vertical direction V. Thus, outlets 232 may be spaced apart from fluid conduit couplings 228 along the lateral direction L and/or the transverse direction T. In addition, as may be seen in FIG. 4, each group of outlets 232 may be formed into an array with more outlets 232 in columns of the array running parallel to the transverse direction T than outlets 232 in rows of the array running parallel to the lateral direction L. Thus, in the exemplary embodiment shown in FIG. 4, first outlets 238 include two outlets in each row of the array running parallel to the lateral direction L, and first outlets 238 include eight outlets in each column of the array running parallel to the transverse direction T.

The distribution of outlets 232 over fluid additive compartments 224 may assist with rinsing fluid additive compartments 224. For example, outlets 232 may be dispersed or arranged in a plane that is perpendicular to the vertical direction V over fluid additive compartments 224 such that substantially all of fluid additive compartments 224 is rinsed with liquid from outlets 232 during operation of fluid additive dispenser 220. Thus, the arrangement and spacing of outlets 232 may mirror or complement the shape of fluid additive compartments 224 directly beneath outlets 232, e.g., in a plane that is perpendicular to the vertical direction V.

FIG. 7 illustrates a method 700 for forming a unitary top panel according to an exemplary embodiment of the present subject matter. Method 700 may be used to form any suitable top panel. For example, method 700 may be used to form top panel 200 (FIG. 3). Method 700 permits formation of various features of top panel 200, as discussed in greater detail below. Method 700 includes fabricating top panel 200 as a unitary top panel, e.g., such that top panel 200 is formed of a single continuous piece of plastic, metal or other suitable material. More particularly, method 700 includes manufacturing or forming top panel 200 using an additive process, such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering and other known processes. An additive process fabricates plastic or metal components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 710, three-dimensional information of top panel 200 is determined. As an example, a model or prototype of top panel 200 may be scanned to determine the three-dimensional information of top panel 200 at step 710. As another example, a model of top panel 200 may be constructed using a suitable CAD program to determine the three-dimensional information of top panel 200 at step 710. At step 720, the three-dimensional information is converted into a plurality of slices that each defines a cross-sectional layer of top panel 200. As an example, the three-dimensional information from step 710 may be divided into equal sections or segments, e.g., along a central axis of opening 202 or any other suitable axis. Thus, the three-dimensional information from step 710 may be discretized at step 720, e.g., in order to provide planar cross-sectional layers of top panel 200.

After step 720, top panel 200 is fabricated using the additive process, or more specifically each layer is successively formed at step 730, e.g., by fusing or polymerizing a plastic using laser energy or heat. The layers may have any suitable size. For example, each layer may have a size between about five ten-thousandths of an inch and about one thousandths of an inch. Top panel 200 may be fabricated using any suitable additive manufacturing machine as step 730. For example, any suitable laser sintering machine, inkjet printer or laserjet printer may be used at step 730. It should be understood that fluid additive drawer 222 may be formed with other portions of top panel 200, e.g., at step 730.

Utilizing method 700, top panel 200 may have fewer components and/or joints than known top panels. Specifically, top panel 200 may require fewer components because top panel 200 may be a single piece of continuous plastic or metal, e.g., rather than multiple pieces of plastic or metal joined or connected together. Also, fluid conduit couplings 228, interior volumes 230 and outlets 232 may be integrated into top panel 200 using method 700. As a result, top panel 200 may provide improved wash fluid flow into fluid additive drawer 222, e.g., by dispersing or spray wash fluid in a desired pattern throughout fluid additive compartments 224. Also, top panel 200 may be less prone to leaks and/or be stronger when formed with method 700.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A vertical axis washing machine appliance, comprising:
a tub;
a basket positioned within the tub, the basket rotatable about a vertical axis within the tub;
a fluid additive drawer defining a fluid additive compartment;
a cabinet extending between a top portion and a bottom portion, the tub disposed within the cabinet, the cabinet having a unitary top panel positioned at the top portion of the cabinet, the unitary top panel defining an opening for accessing the basket within the tub, the unitary top panel also defining a fluid conduit coupling, an interior volume, and a plurality of outlets, the interior volume of the unitary top panel extending between and fluidly connecting the fluid conduit coupling and the plurality of outlets, the plurality of outlets positioned over the fluid additive compartment of the fluid additive drawer.

2. The vertical axis washing machine appliance of claim 1, wherein the fluid additive drawer is positioned adjacent a back portion of the unitary top panel.

3. The vertical axis washing machine appliance of claim 2, wherein the fluid additive drawer is slidably mounted to the unitary top panel at the back portion of the unitary top panel.

4. The vertical axis washing machine appliance of claim 1, wherein the fluid additive drawer defines a plurality of fluid additive compartments and the unitary to panel defines a plurality of fluid conduit couplings and a plurality of interior volumes, each interior volume of the plurality of interior volumes extending between and fluidly connecting a respective one of the fluid conduit couplings and respective ones of the plurality of outlets, outlets of the plurality of outlets positioned directly over each fluid additive compartment of the fluid additive drawer.

5. The vertical axis washing machine appliance of claim 1, wherein the vertical axis washing machine appliance defines a lateral direction and a transverse direction that are perpendicular to each other and the vertical axis, the plurality of outlets spaced apart from one another along the lateral and transverse directions.

6. The vertical axis washing machine appliance of claim 1, wherein the plurality of outlets is positioned directly over the fluid additive compartment of the fluid additive drawer such that liquid exiting the plurality of outlets flows into the fluid additive compartment of the fluid additive drawer.

7. The vertical axis washing machine appliance of claim 1, wherein the plurality of outlets comprises more than four outlets and less than two hundred outlets.

8. The vertical axis washing machine appliance of claim 1, further comprising a lid rotatably mounted to the unitary top panel over the opening of the unitary top panel.

9. The vertical axis washing machine appliance of claim 1, wherein the unitary top panel of the cabinet is a single continuous piece of material.

10. The vertical axis washing machine appliance of claim 9, wherein the unitary top panel of the cabinet is a single continuous piece of plastic.

11. A method for forming a unitary top panel for a vertical axis washing machine appliance, comprising:
establishing three-dimensional information of the unitary top panel;
converting the three-dimensional information of the unitary top panel from said step of establishing into a plurality of slices, each slice of the plurality of slices defining a respective cross-sectional layer of the unitary top panel; and
successively forming each cross-sectional layer of the unitary top panel with an additive process;
wherein, after said step of successively forming: (1) the unitary top panel defines an opening for accessing a basket of the vertical axis washing machine appliance; (2) the unitary top panel also defines a fluid conduit coupling, an interior volume, and a plurality of outlets; and (3) the interior volume of the unitary top panel extends between and fluidly connects the fluid conduit coupling and the plurality of outlets.

12. The method of claim 11, further comprising mounting a fluid additive drawer to the unitary top panel after said step of successively forming such that the plurality of outlets is positioned over a fluid additive compartment of the fluid additive drawer.

13. The method of claim 12, wherein the fluid additive drawer is positioned adjacent a back portion of the unitary top panel.

14. The method of claim 12, wherein the plurality of outlets is positioned directly over the fluid additive compartment of the fluid additive drawer such that liquid exiting the plurality of outlets flows into the fluid additive compartment of the fluid additive drawer.

15. The method of claim 12, wherein the fluid additive drawer defines a plurality of fluid additive compartments, the unitary to panel defining a plurality of fluid conduit couplings and a plurality of interior volumes after said step of successively forming, each interior volume of the plurality of interior volumes extending between and fluidly connecting a respective one of the fluid conduit couplings and respective ones of the plurality of outlets, outlets of the plurality of outlets positioned directly over each fluid additive compartment of the fluid additive drawer.

16. The method of claim 11, wherein the plurality of outlets comprises more than four outlets and less than two hundred outlets after said step of successively forming.

17. The method of claim 11, wherein the vertical axis washing machine appliance defines a lateral direction and a transverse direction that are perpendicular to each other and the vertical axis, the plurality of outlets spaced apart from one another along the lateral and transverse directions after said step of successively forming.

18. The method of claim 11, further comprising rotatably mounting a lid to the unitary top panel at the opening of the unitary top panel after said step of successively forming.

19. The method of claim 11, wherein the unitary top panel of the cabinet is a single continuous piece of material after said step of successively forming.

20. The method of claim 11, wherein the unitary top panel of the cabinet is a single continuous piece of plastic after said step of successively forming.
